(19) United States
(12) Patent Application Publication
(10) Pub. No.: US 2024/0222896 A1
(43) Pub. Date: Jul. 4, 2024

(54) ELECTRIC CONNECTOR

(71) Applicant: BIZLINK INTERNATIONAL CORP., New Taipei City (TW)

(72) Inventors: Yanping ZHANG, New Taipei City (TW); Qixing XU, New Taipei City (TW); Haoran ZOU, New Taipei City (TW)

(21) Appl. No.: 18/400,181

(22) Filed: Dec. 29, 2023

(30) Foreign Application Priority Data
Jan. 3, 2023 (CN) 202310004202.2

(51) Int. Cl. H01R 13/04; H01R 13/40

(52) U.S. Cl. CPC H01R 13/04; H01R 13/40

(57) ABSTRACT

An electric plug-in connector terminal structure includes a pin and a female terminal. The pin has an insulating sleeve. The insulating sleeve is disposed at a front end of the pin. The insulating sleeve has an annular guiding slope. The annular guiding slope expands from a root of the insulating sleeve. The female contact has a guiding slope. The guiding slope is disposed at a front end of the female terminal. The guiding slope is inclined. An inclination direction of the annular guiding slope is the same as an inclination direction of the guiding slope.

### RELATED APPLICATIONS

This application claims priority to Chinese Application Serial Number CN202310004202.2, filed Jan. 3, 2023, which is herein incorporated by reference in its entirety.

### BACKGROUND

### Technical Field

The present disclosure relates to high power connectors. More particularly, the present disclosure relates to high power connectors having an improved pin with an insulating sleeve.

### Description of Related Art

High power providing connector, such as BzHPC H3 Power Whip AC Input Connector of BizLink, includes a plurality of pins for connecting with another connector for power transmission.

Pins in the said type of connector are usually cylindrical-shaped, and the front end of the power-supplying pin has a dome-shaped insulating sleeve to decrease the chance of the pin being damaged from arcing and also perform the guidance function during insertion. In the guidance process, the petals of the female contact contact with the insulating sleeve, and then the functional areas or working portion of the pin and the female terminal will come into direct contact for power transmission. In a high-temperature environment during plugging and unplugging, the insulating sleeve may easily undergoes carbonization and become fragile. If the female contact contacts with the insulating plastic at this time, the insulating sleeve may be scratched and damaged. Additionally, its carbonized particles formed on the surface of the insulating sleeve may adhere to the contact surface of the female contact, resulting in reduced conduction efficiency.

### SUMMARY

A technical aspect of the present disclosure is to provide a high power connector, which can solve the problem of damage of the insulating sleeve and the female contact pollution problem, when the pin is inserted into the female terminal.

According to an embodiment of the present disclosure, an electric connector includes a pin. The pin includes a pin body and an insulating sleeve. The pin body has a guiding portion for guidance and a working portion for power transmission. The guiding portion has an inclined surface. The guiding portion is connected with the working portion. The guiding portion forms a front end of the pin body. The insulating sleeve is secured at the front end of the pin body.

In one or more embodiments of the present disclosure, a maximum diameter of the insulating sleeve is smaller than a maximum diameter of the guiding portion.

In one or more embodiments of the present disclosure, the guiding portion has a platform. The insulating sleeve is secured on the platform.

In one or more embodiments of the present disclosure, the maximum diameter of the insulating sleeve is smaller than or equal to a maximum diameter of the platform.

In one or more embodiments of the present disclosure, an outer edge of the insulating sleeve is located within an outline of the platform.

In one or more embodiments of the present disclosure, the insulating sleeve is shifted away from the inclined surface in an axial direction of the pin body.

In one or more embodiments of the present disclosure, the insulating sleeve is shaped as a truncated cone. The insulating sleeve gradually converges away from the front end of the pin body.

In one or more embodiments of the present disclosure, an average slope of the inclined surface of the pin body in an axial direction of the pin body is substantially same as the insulating sleeve in the axial direction.

In one or more embodiments of the present disclosure, a height of the insulating sleeve is smaller than one of a maximum diameter of the platform and a maximum diameter of the working portion.

In one or more embodiments of the present disclosure, the height of the insulating sleeve is smaller than 0.7 times of a maximum diameter of the insulating sleeve.

In one or more embodiments of the present disclosure, the height of the insulating sleeve is smaller than 0.6 times of a maximum diameter of the insulating sleeve.

### BRIEF DESCRIPTION OF THE DRAWINGS

The disclosure can be more fully understood by reading the following detailed description of the embodiments, with reference made to the accompanying drawings as follows:

FIG. 1 is a schematic view of a pin and a female terminal according to an embodiment of the present disclosure;

FIG. 2 is a cross-sectional view of the pin and female terminal of FIG. 1;

FIG. 3 is a schematic view of plugging processes of the pin and female terminal of FIG. 1; and

FIG. 4 is an enlarged view of zone A of FIG. 3.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the present embodiment, a cable end connector (Plug), for example, BzHPC H3 Power Whip AC Input Connector, is disclosed for connecting with another connector (socket) connected with a power consumption device (such as a server).

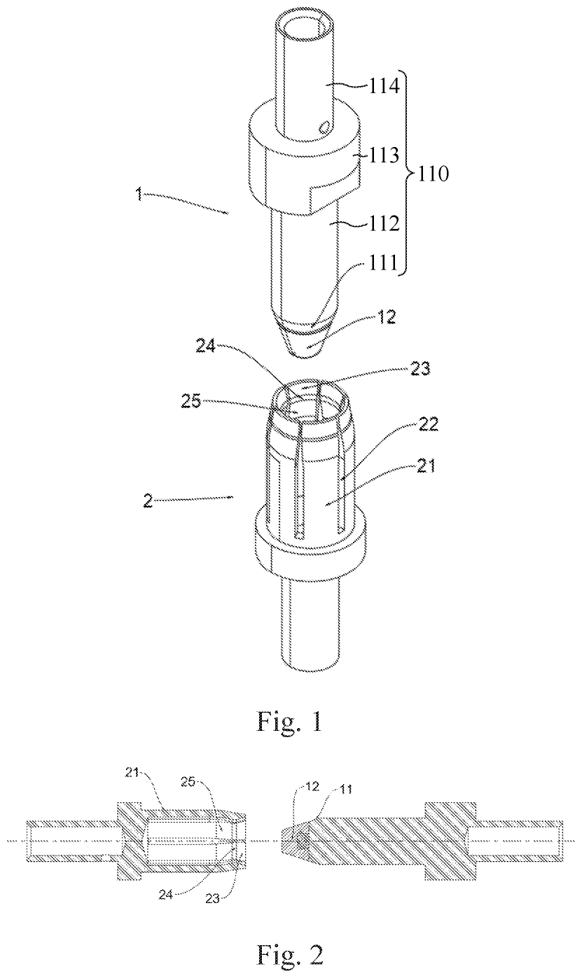

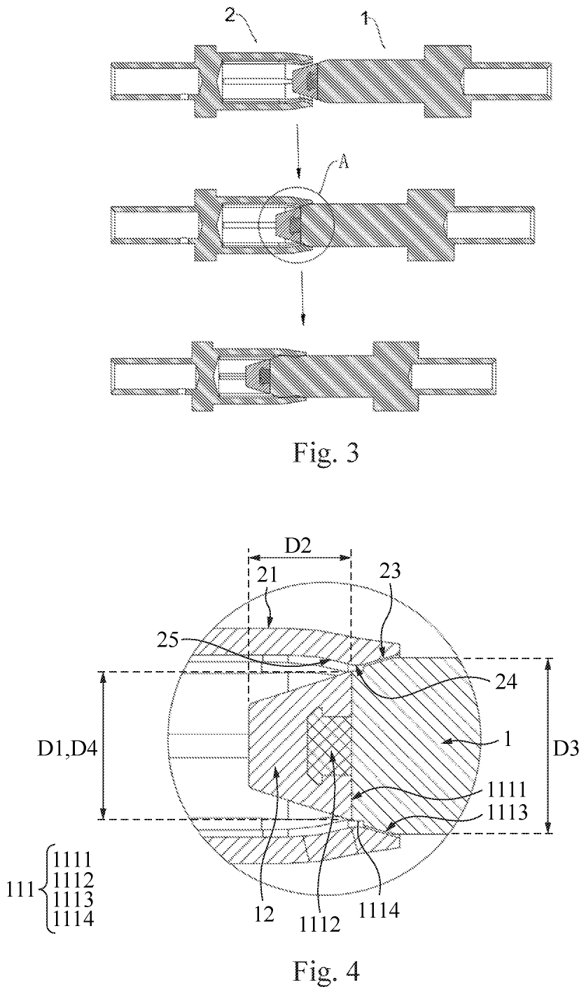

The cable end connector has at least a cable, a housing, and a plurality of pins 1. The pins 1 are plugged and secured into the housing respectively. Reference is made to FIGS. 1-4. The pin 1 of the plug and the female contact 2 of the socket are depicted in FIG. 1 to FIG. 4.

The front end of the female contact 2 is mainly formed of six pieces of terminal strip 21 arranged in an annular matrix. The terminal strips 21 are elastic and deformable. The terminal strips 21 surround to form an insertion hole for the pin 1. The pin 1 is inserted into the female contact 2 through the insertion hole. Adjacent two of the terminal strips 21 have a gap 22 therebetween, such that an avoidance space is provided when the terminal strips 21 are deformed. The front portion of each of the terminal strips 21 is disposed with a guiding slope 23, which facilitates to guide the pin 1 to insert into the insertion hole. Each of the terminal strips 21 has a body and a connecting surface 25. The connecting surface 25 is located between the body and the guiding slope 23. Each of the connecting surfaces 25 is inclined. The inclination direction of each of the connecting surfaces 25 is opposite to the inclination direction of the guiding slope 23. A connecting region between the connecting surfaces 25 and the guiding slope 23 has a curved protrusion 24. The curved protrusion 24 forms a functional region of the female contact 2.

In the present embodiment, the pin 1 is mainly formed of a pin body 11 and an insulating sleeve 12.

The pin body 11 is one-piece-formed of a conductive metal, such as copper. The pin body 11 has a guiding portion 111, a working portion 112, a fixing portion 113, and a hollow portion 114 arranged in sequence.

The guiding portion 111 is utilized to guide with the female contact 2. The guiding portion 111 is substantially shaped as a truncated cone. The guiding portion 111 gradually converges toward the front end of the pin body 11. The front end of the guiding portion 111 has a platform 1111, a protrusion 1112, an inclined surface 1113 and a stepped structure 1114.

The protrusion 1112 is located on the center of platform 1111. The protrusion 1112 is substantially T-shaped, or cylindrically-shaped with an extended flange on the front edge thereof. The flange has a front facing sloped surface formed thereon.

The shaped inclined surface 1113 is inclined/sloped and connects the platform 1111 with the stepped structure 1114. The inclination direction of the inclined surface 1113 of guiding portion 111 is substantially the same as the inclination direction of the guiding slope 23. The inclined surface 1113 is substantially ring-shaped. In other words, the inclined surface 1113 can be an annular guiding slope gradually expanding from the stepped structure 1114 towards the platform 1111. The stepped structure 1114 connects with the working portion 112.

The working portion 112 is rod-shaped and the surface thereof extends substantially parallel to the length of the plug 1 and is utilized to connect with the female contact 2 for transmitting power.

The fixing portion 113 is also rod-shaped and has a larger diameter than the working portion 112. The fixing portion 113 is utilized to limit the position of the pin 1 in the housing of the plug.

The hollow portion 114 is hollow and is utilized to allow a core wire of a cable to be soldered therein for electrical connection.

The insulating sleeve 12 may be one-piece-formed of an insulating material with good heat-resistant performance, for example, various types of synthetic fiber materials. In the present embodiment, the insulating sleeve 12 is formed directly onto the protrusion 1112 and the platform 1111 by insert molding so as to secure therewith. As an alternative, the insulating sleeve 12 can also be formed independently and adhered or assembled with the protrusion 1112 on the platform 1111 afterwards. Through this configuration, the insulating sleeve 12 is prevented from being easily detached after being fixed on the protrusion 1112. In details, the insulating sleeve 12 is shaped as a truncated cone and gradually converges forward from the platform 1111 or the front end of the connecting body 11. The back end of the insulating sleeve 12 is connected with the platform 1111. The insulating sleeve 12 is smaller than the opening of the insertion hole of the female contact 2 for preventing from contact.

In this embodiment, when the pin 1 is plugging into the female contact 2, the insulating sleeve 12 of the pin 1 is first inserted into the female contact 2. Since the insulating sleeve 12 is conical in shape and the maximum diameter D1 of the insulating sleeve 12 is smaller than the diameter of the insertion hole, the terminal strips 21 of the female contact 2 will not contact with insulating sleeve 12 and are in contact with the guiding portion 111 of the pin body 11 instead, so as to decrease the chance of the insulating sleeve 12 being scratched and damaged in a high temperature environment cased by arcing or hot-plugging, etc.

Moreover, for preventing the problems of “scratching” and “pollution”, the pin 1 is suggested to be formed as follows. For example, as depicted in FIG. 4, the maximum diameter D1 of the insulating sleeve 12 is suggested to be smaller than the maximum diameter D3 of the guiding portion 111, the said diameter D3 is usually the same as the diameter of the working portion 112.

Moreover, the maximum diameter D1 of the insulating sleeve 12 is smaller than or at least equal to the maximum diameter D4 of the platform 1111, and an outer edge of the insulating sleeve 12 is suggested not extending beyond an outline of the platform 1111 or the stepped structure 1114. In other words, the outer edge of the insulating sleeve 12 is located within the outline of the platform 1111 or the stepped structure 1114.

Furthermore, the size of insulating sleeve 12 is suggested to be limited and not to overlap with the guiding portion 111 in the axial direction of the pin body 11. In other words, the insulating sleeve 12 is shifted away from the inclined surface 1113 in the axial direction of the pin body. A “gap” preserved by the stepped structure 1114 is also preferred. In other words, when viewed from the left to the right side of FIG. 2, one would see a solid circular insulating sleeve 12, and an outermost annular inclined surface 1113 separated by an annular stepped structure 1114.

By the said designs, the chance of insulating sleeve 12 being contact with the high temperature female contact 2 can be decreased.

Moreover, the inclined surface 1113 is relatively gentle, which means that the angle of the inclined surface 1113 relative to the extension direction (equal to the axial direction) of the pin body is small. For example, this angle is smaller than 30 degree to the extension direction of the pin body 11. By this means, the exposed cross-sectional area of the inclined surface 1113 to the female terminal 2 can be minimized, thereby reducing the likelihood of arcing.

Moreover, the average slope of the inclined surface 1113 to the extension direction of the pin body 11 is substantially the same as the average slope of the outer slope of the insulating sleeve 12, and the slope difference may be smaller than 10%.

Furthermore, the height D2 of the insulating sleeve being smaller than the maximum diameter D1 of the platform, the maximum diameter D4 of the insulating sleeve 12 and the maximum diameter of the working portion 112 of the pin body 11 at the same time is suggested, for making the insulating sleeve 12 shorter and reducing the surface area thereof, resulting in the decrease of total amount of carbonized particles released via space thereby, further improving the pollution problem.

By the said designs, when the pin 1 inserts into the female contact 2, instead of contacting with the insulating sleeve 12, the guiding portion 111 of the connecting body 11 of the pin 1 contacts with the guiding slopes 23 on the terminal strips 21 of the female contact 2. In this way of guidance, the insulating sleeve 12 used for arc-preventing is not required to provide guidance during insertion, solving the problem of damage of the insulating sleeve 12 in the prior art, and the chance that female contact 2 being contact and polluted by the carbonized insulating sleeve 12 can be decreased.

In summary, by making the insulating sleeve 12 smaller to avoid contact with the female contact 2, and forming an inclined surface 1113 at the peripherals of the front end of the pin body 11 to provide a guiding function during the plug/unplugging process, the problem of damage of the insulating sleeve 12 and the problem of pollution of the female contact 2 can be overcome at a certain degree.

What is claimed is:

1. An electric connector, comprising:
a pin, comprising:
a pin body, the pin body having a guiding portion for guidance and a working portion for power transmission, the guiding portion having an inclined surface, the guiding portion being connected with the working portion, the guiding portion forming a front end of the pin body; and
an insulating sleeve secured at the front end of the pin body.

2. The electric connector of claim 1, wherein a maximum diameter of the insulating sleeve is smaller than a maximum diameter of the guiding portion.

3. The electric connector of claim 2, wherein the guiding portion has a platform, the insulating sleeve is secured on the platform.

4. The electric connector of claim 3, wherein the maximum diameter of the insulating sleeve is smaller than or equal to a maximum diameter of the platform.

5. The electric connector of claim 1, wherein an outer edge of the insulating sleeve is located within an outline of the platform.

6. The electric connector of claim 1, wherein the insulating sleeve is shifted away from the inclined surface in an axial direction of the pin body.

7. The electric connector of claim 1, wherein the insulating sleeve is shaped as a truncated cone, the insulating sleeve gradually converges away from the front end of the pin body.

8. The electric connector of claim 7, wherein an average slope of the inclined surface of the pin body in an axial direction of the pin body is substantially same as the insulating sleeve in the axial direction.

9. The electric connector of claim 1, wherein a height of the insulating sleeve is smaller than one of a maximum diameter of the platform and a maximum diameter of the working portion.

10. The electric connector of claim 9, wherein the height of the insulating sleeve is smaller than 0.7 times of a maximum diameter of the insulating sleeve.

11. The electric connector of claim 9, wherein the height of the insulating sleeve is smaller than 0.6 times of a maximum diameter of the insulating sleeve.
